(19) United States
(12) Patent Application Publication
(10) Pub. No.: US 2005/0122708 A1
(43) Pub. Date: Jun. 9, 2005

(54) Dehumidifier for hearing aids

(76) Inventor: Jack L. Kennedy, Phoenix, AZ (US)

Correspondence Address: C. Robert von Hellens;CAHILL, VON HELLENS & GLAZER P.L.C., Suite 155, 2141 E. Highland Avenue, Phoenix, AZ, 85016, US

(21) Appl. No.: 10/729,137

(22) Filed: Dec. 5, 2003

(51) Int. Cl. F27D 21/02

(52) U.S. Cl. 362/92

(57) ABSTRACT

A conventional night light is adapted to support one or more hearing aids on a perforated shelf located above the lamp of the night light. The air warmed by the lamp penetrates the perforations and bathes the hearing aid to increase the temperature of the hearing aid by a few degrees. Additionally, the warmed air may penetrate the hearing aid through the various apertures therein. The combination of warmed hearing aid and warmed air flow therethrough will tend to evaporate any moisture within the hearing aid and reduce the likelihood of deterioration of electrical components due to the presence of moisture and the longevity of the hearing aid will be greatly enhanced. In another embodiment, a lamp disposed in one compartment is energized to warm the surrounding air and cause an upward flow of air through a perforated bottom of a second compartment containing one or more hearing aids.

### BACKGROUND OF THE INVENTION

1. Field of the Invention

The present invention relates to maintenance devices for hearing aids and, more particularly, to a dehumidifier for removing moisture from within a hearing aid.

2. Description of the Related Art

The most popular hearing aids presently in use are mounted within the ear canal with a portion extending outwardly and contoured to fit the central part of the ear lobe. These hearing aids receive, amplify and transmit into the ear canal audible sounds. Circuitry and related mechanical components for sensing, amplifying and transmitting the audible sounds are located within the envelope defining the hearing aid. Additionally, a power source, such as a small button cell, is removably mounted within the hearing aid. Usually, a finger operated knob permits adjustment of the degree of amplification. To facilitate replacement of the button cell, a flap or door is hingedly attached and includes a snap lock to secure closing and prevent inadvertent loss of the button cell.

Because the hearing aid includes a number of openings in the exterior surface to accommodate the thumb wheel operating a rheostat, the door for the button cell and openings through which sounds are received and transmitted, inflow of moisture can and does occur. Such moisture, when in contact with any of the many electrical/electronic components within the hearing aid will tend to cause corrosion of any non inert materials.

The moisture that seeps or migrates into a hearing aid is generally not in liquid form. Instead, it usually occurs as a result of air flow into the hearing aid. Normally, ambient air includes a degree of humidity as a function of the ambient temperature and general local atmospheric conditions. A user's body will perspire and such perspiration may seep into a hearing aid. Usually, perspiration contains numerous dissolved salts of various types that may interact with non inert components resulting in corrosion or deterioration of such components. As perspiration will evaporate, the resulting moisture laden air may seep or migrate into the hearing aid as it is in direct contact with a user's skin.

It is therefore evident that a hearing aid is normally used in an environment which may be destructive to operation of the hearing aid over a period of time. To prevent such destruction and loss of use and in consideration for the significant costs of replacement, periodic maintenance by a qualified professional should be performed on a regular basis. Such maintenance necessarily requires that a user be without one or both hearing aids for a period of time. The resulting loss or reduced hearing capability will be embarrassing and potentially dangerous to the user. Moreover, the expenses of periodic maintenance are not insignificant.

### SUMMARY OF THE INVENTION

By regularly and frequently drying any moisture present within a hearing aid in a dehumidifier, the likelihood of deterioration of non inert components within the hearing aid are significantly reduced. A source of heat in the dehumidifier raises the temperature of the hearing aid above ambient temperature to cause any moisture therewithin to evaporate and thereby reduce the time of such moisture is in contact with components subject to deterioration from water. More particularly, a conventional night light is adapted to support placement of one or more hearing aids within a compartment subject to a flow of warmed air emanating from the associated low wattage light bulb. The small rise in temperature of the hearing aid and any flow of warmed air into the hearing aid will cause evaporation of any moisture therein. As most users require a hearing aid only during waking hours, the use of a night light is particularly beneficial as it generally includes a light sensitive sensor for actuating the night light only during periods of darkness while the user is sleeping and has no need for a hearing aid.

It is therefore a primary object of the present invention to provide a dehumidifier for evaporating moisture collected within a hearing aid.

Another object of the present invention is to provide an inexpensive apparatus useable periodically for warming a hearing aid to cause evaporation of any moisture therein.

Yet another object of the present invention is to provide a dehumidifier for evaporating moisture within a hearing aid during periods of darkness.

Still another object of the present invention is to provide an adaptation of a conventional night light to remove moisture within a hearing aid.

A further object of the present invention is to provide an inexpensive low maintenance source of heat for periodically removing moisture from within a hearing aid.

A yet further object of the present invention is to provide a method for inexpensively extending the useful life of a hearing aid.

A still further object of the present invention is to provide a method for periodically removing moisture from within a hearing aid with an inexpensive easy to use dehumidifier.

These and other objects of the present invention will become more apparent to those skilled in the art as the description of the present invention proceeds.

### BRIEF DESCRIPTION OF THE DRAWINGS

The present invention will be described with greater specificity and clarity with reference to the following drawings, in which:

FIG. 1 is a perspective view of a conventional night light adapted as a dehumidifier for use with a hearing aid;

FIG. 2 is a partial cross sectional view taken along lines 2-2, as shown in FIG. 1;

FIG. 3 is an exploded view of a variant of the dehumidifier shown in FIG. 1;

FIG. 4 is a partial cross sectional view taken along lines 4-4, as shown in FIG. 3;

FIG. 5 illustrates a yet further embodiment of the present invention;

FIG. 6 is a partial cross sectional view taken along lines 6-6, as shown in FIG. 5;

FIG. 7 is a further cross sectional view of the embodiment shown in FIG. 5; and

FIG. 8 illustrates an alternative power source for the embodiment shown in FIG. 5.

### DESCRIPTION OF THE PREFERRED EMBODIMENT

Referring to FIG. 1 there is shown a dehumidifier 10 for use with one or more hearing aids 12. Preferably, these hearing aids are of the type that are essentially completely inserted within the canal of an ear or protruding slightly therefrom to provide access to a thumb wheel 14 serving as a volume control. The dehumidifier may be developed from a conventional and widely available night light 16 having a pair of prongs 18 serving in the manner of a plug for electrical interconnection with a conventional electrical wall socket 20. Such a wall socket usually includes a face plate 22.

Night light 16 includes a base 24 supporting a lamp socket 26 for engaging a low wattage lamp 28. Normally, such a light is rated at or about 4 watts. A light sensor 30 senses the level of ambient light. If the ambient light level drops below a predetermined degree of illumination, a switch within base 24 is closed and the circuit providing electrical power to socket 26 is energized and lamp 28 will be lighted. Thus, night light 16 will provide a low level of illumination when the surrounding area is at or above a certain level of darkness. It therefore follows that the night light will be on essentially only during night time.

Referring jointly to FIGS. 1 and 2, details attendant the present invention will be described. Base 24 usually supports a transparent or at least translucent three sided shield 32. The purpose of this shield is to permit transmission of light therethrough while simultaneously preventing contact with lamp 28 to prevent damage thereto and to prevent contact with the lamp and possible damage. Furthermore, the shield may include a pattern or a configuration to provide defused light to the surrounding area. Not only will lamp 28 provide illumination but it will also provide a modicum of heat when lighted.

Dehumidifier 10 for use to dry one or more hearing aids 12 incorporates the operative features of night light 16. In particular, a shelf 40 is secured to shield 32 at a location above lamp 28. This shelf includes a plurality of perforations 42 to accommodate air flow therethrough. This air flow is primarily generated by the air in and about lamp 28 being heated and subsequently rising convectively. Preferably but not necessarily, a rear wall 44 extends between edges 34, 36 of shield 32 and is in engagement with rear side 46 of shelf 40. Thus, a compartment 48 having an apertured bottom and an open top is formed above lamp 28.

When lamp 28 of dehumidifier 10 is energized, the air adjacent the lamp will rise by convection. The rising heated air will flow through perforations 42 in shelf 40 into compartment 48. One or more hearing aids 12 placed within the compartment will become bathed in air heated above ambient temperature. The warmed air will raise the temperature of the hearing aid a few degrees. Furthermore, the heated air may flow into and out of the hearing aid through the various apertures present therein. The combination of warming the hearing aid and the warmed air flowing therethrough will urge evaporation of any moisture present therein. With such evaporation, the likelihood of deterioration due to contact with water/moisture of any non inert components, such as electrical components, is greatly reduced.

By experimentation, it has been learned that the quality of the sound produced by a previously well used hearing aid was enhanced over a period of time of regular use of dehumidifier 10. One can only assume that such beneficial results are due to ultimate complete drying of all components which resulted in enhancement of their operation at or in excess of the initial sound quality standards.

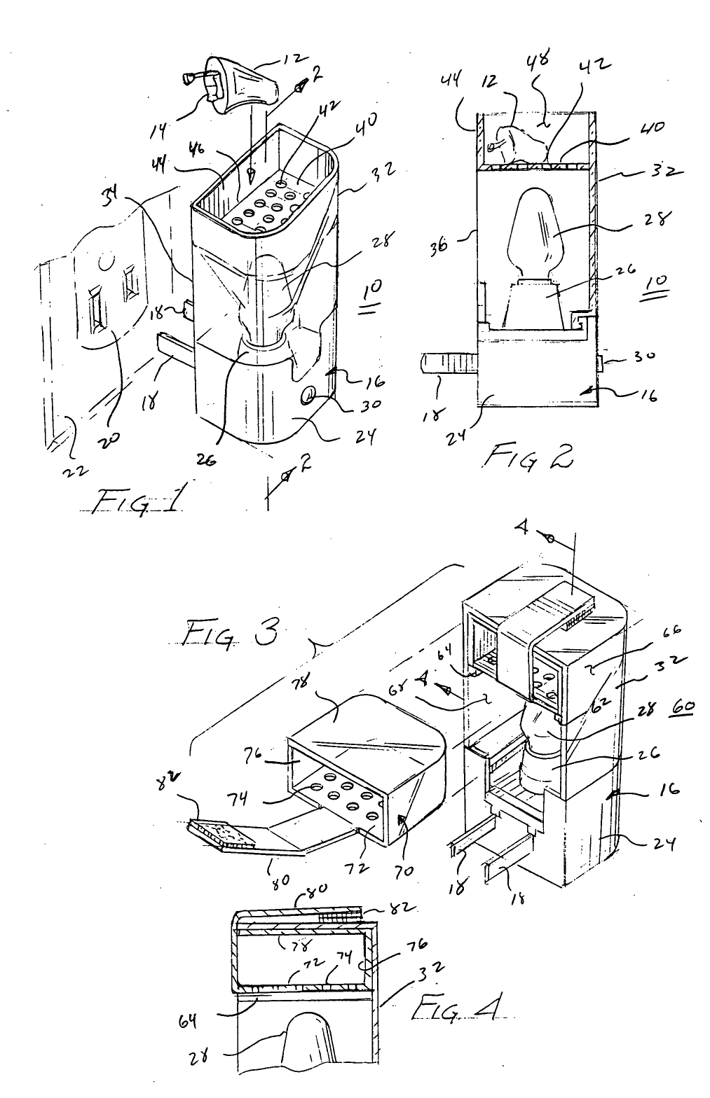

Referring jointly to FIGS. 3 and 4, there is shown a variant dehumidifier 60. This variant is based upon a night light 16 like that shown in FIGS. 1 and 2 and described above. Accordingly, with respect to common elements, identical reference numerals will be used. A pair of supports 62, 64 extend from sides 66, 68 of shield 32. A housing 70 includes a bottom 72 having a plurality of perforations 74 disposed therein. The configuration of the bottom is generally coincident with the configuration of the internal cross section of shield 32. A side wall 76 extends upwardly from the front and side edges of bottom 72 and a top 78 extends to and is joined to this wall. Thus, housing 70 includes an open side. One or more hearing aids may be placed in and/or retrieved from housing 70 through this open side. To prevent the hearing aid or hearing aids from falling out of the housing, a strap 80 may be used. This strap extends from bottom 72 to a location on top 78, as illustrated. To retain the strap in place, it may be removably secured by use of a common hook and loop fastener 82, which fastener may be of the type sold under the trademark VELCRO.

In operation, one or more hearing aids 12 is placed within housing 70 and strap 80 is closed to retain the hearing aid(s) therein. The housing is then mounted within night light 16 by resting it upon supports 62, 64. When lamp 28 is energized, warmed air will enter housing 70 through perforations 74 and bathe the hearing aid(s) with warmed air. The warmed air will outflow through the open side of the housing. Thereby, the hearing aid(s) is continually bathed by warmed air.

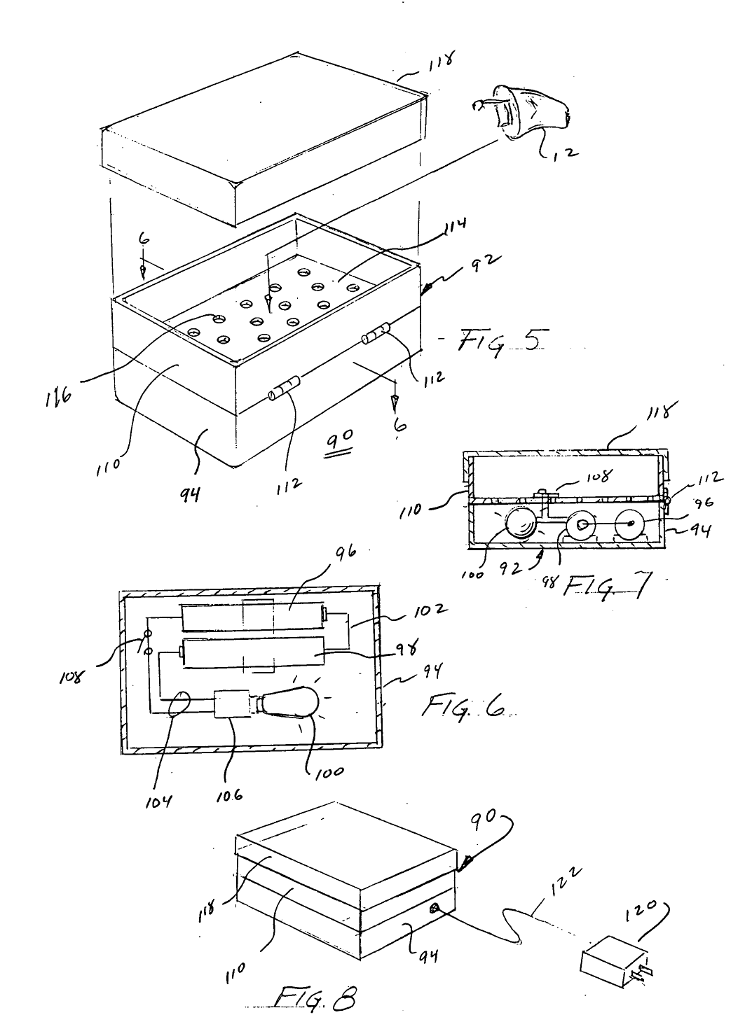

Referring jointly to FIGS. 5, 6 and 7, a further variant of a dehumidifier 90 for hearing aids will be described. A box 92 includes a lower compartment 94 housing one or more batteries 96, 98 for providing electrical power to a small lamp 100. The batteries may be connected in series as represented by electrical conductor 102. A pair of electrical conductors 104 interconnect lamp 100 through socket 106 with the batteries. A conventional electrical switch 108 is disposed in one of electrical conductors 104 to control energization and deenergization of lamp 100.

A second compartment 110 may be hingedly attached to compartment 94 by hinges 112. Compartment 110 includes a bottom 114 having a plurality of perforations 116 disposed therein. A lid 118 may be detachably attached, as illustrated, to close compartment 110. Alternatively, it may be hingedly attached in the conventional manner.

In operation, actuation of switch 108 will energize lamp 100. Upon energization, the lamp will become warm and the air there around will be heated. The heated or warmed air will rise and permeate through perforations 116 into compartment 110 and the air within compartment 110 will be raised. By placing one or more hearing aids 12 within compartment 110, they will be heated and the warmed air will flow into and out of the hearing aid through the various openings therein. Such heating and warmed air flow will cause moisture within the hearing aid to evaporate. Such evaporation will reduce or eliminate contamination and/or deterioration of any non inert electrical components within the hearing aid. It is to be appreciated that compartment 94 may include one or more apertures to enhance air flow through compartment 94 by convection. Similarly, lid 118 or the side wall of compartment 110 may include one or more apertures to enhance outflow of air from within compartment 1 10 and enhance flow of warmed air in and about any hearing aids placed within the compartment.

FIG. 8 illustrates another power source for dehumidifier 90. Instead of using batteries, as shown in FIGS. 6 and 7, to avoid the need for periodic replacement, conventional AC house current may be used to energize lamp 100. In such event, a conventional electrical plug 120 is engaged with a conventional wall socket. An electrical cord 122 conveys electric power from the plug to circuitry within dehumidifier 90. Depending upon the voltage of the lamp being used, appropriate circuitry well known to those skilled in the art would be employed within compartment 94 to energize the lamp.

1. In a night light having a base for supporting a low wattage lamp energized by a pair of prongs forming a conventional electric plug adapted for electrical connection with a conventional wall socket, a light transmissive shield extending from the base past the lamp and having an upper edge, the improvement comprising in combination:
a) a shelf extending from the shield and above the lamp and adapted to support at least one hearing aid; and
b) at least one perforation disposed in said shelf to accommodate air flow therethrough from about the lamp to the area above said shelf and about the hearing aid.

2. The improvement as set forth in claim 1 including a plurality of perforations disposed in said shelf.

3. The improvement as set forth in claim 1 wherein said shelf is located below the upper edge of the shield.

4. The improvement as set forth in claim 1 wherein the shield includes three sides and wherein said shelf is in engagement with each of the three sides of the shield.

5. The improvement as set forth in claim 4 wherein said shelf is located below the upper edge of the shield.

6. The improvement as set forth in claim 5 including a plurality of perforations disposed in said shelf.

7. The improvement as set forth in claim 4 including a plurality of perforations disposed in said shelf.

8. The improvement as set forth in claim 4 wherein said shelf includes four edges and a side wall extending from three of said four edges.

9. The improvement as set forth in claim 8 including a top secured to said side wall to define a housing.

10. The improvement as set forth in claim 9 wherein said housing includes an open side.

11. The improvement as set forth in claim 10 including a strap adapted to extend across said open side.

12. The improvement as set forth in claim 11 wherein said strap is attached to one of said shelf and said top.

13. The improvement as set forth in claim 12 including a fastener for detachably attaching said strap to one of said shelf and said top, said strap being fixedly attached to the other of said shelf and said top.

14. A dehumidifier for a hearing aid, said dehumidifier comprising in combination:
a) a bottom compartment for containing a lamp;
b) a top compartment adapted to receive a hearing aid;
c) said top compartment including a perforated bottom adapted to pass air warmed by said lamp into said top compartment; and
d) a source of electrical power for energizing said lamp.

15. The dehumidifier as set forth in claim 14 including a lid for closing said top compartment.

16. The dehumidifier as set forth in claim 14 wherein said source of electrical power is at least one battery disposed in said bottom compartment.

17. The dehumidifier as set forth in claim 16 including a lid for closing said top compartment.

18. A method for evaporating moisture within a hearing aid, said method comprising the steps of:
a) inserting a night light into a wall socket to light a lamp of the night light;
b) placing the hearing aid on a shelf of the night light above the lamp;
c) accommodating a flow of warmed air from about the lamp and through the shelf; and
d) bathing the hearing aid with the warmed air flowing from about the lamp.

19. The method as set forth in claim 18 including the step of partly enveloping the hearing aid within a housing.

20. The method as set forth in claim 19 including the step of selectively retaining the hearing aid within the housing.
